(19) United States
(12) Patent Application Publication
(10) Pub. No.: US 2017/0200184 A1
(43) Pub. Date: Jul. 13, 2017

(54) CONFIGURABLE ELEMENT TRACKING PLATFORM

(71) Applicant: Persuade Loyalty, LLC, Minneapolis, MN (US)

(72) Inventors: John Tschida, Winter Garden, FL (US); William Jansen, Bloomington, MN (US)

(21) Appl. No.: 15/402,477

(22) Filed: Jan. 10, 2017

Related U.S. Application Data
(60) Provisional application No. 62/277,291, filed on Jan. 11, 2016.

(51) Int. Cl. G06Q 30/02

(52) U.S. Cl. CPC G06Q 30/0226; G06Q 30/0233

(57) ABSTRACT

A configurable element tracking platform configured to provide an interaction indication is presented. The platform comprises a database configured to store a user history for a user and an active interaction criteria. The platform also comprises user action analyzer logic configured to receive an indication of an action by the user and identify an action indication. The platform also comprises a data processing system configured to retrieve, using interaction retrieval logic, the interaction indication. The interaction indication comprises a criteria. The data processing system is further configured to, using interaction check logic, compare the action indication to the criteria and, if the action indication matches the criteria, generate a match indication, using interaction alerting logic.

### CROSS-REFERENCE TO RELATED APPLICATION

The present application is based on and claims the benefit of U.S. Provisional Patent Application Ser. No. 62/277,291 filed Jan. 11, 2016, the content of which is hereby incorporated by reference in its entirety.

### BACKGROUND

Consumer and business loyalty programs continue to proliferate. Programmatic loyalty tracking systems have been evolving to support the various loyalty programs and their ongoing changing requirements. Many businesses offer loyalty programs to their customers. The simpler programs include punch cards and ‘buy-one, get-one free’ schemes. Typically, loyalty service providers track loyalty programs based on a fixed software design—a single software solution is built and designed to support one industry and industry-specific loyalty initiative. Fixed software designs may be developed in-house and are often limited to one specific industry.

### BRIEF DESCRIPTION OF THE FIGURES

FIG. 1 illustrates a block diagram of a configurable element tracking platform in accordance with one embodiment of the present invention.

FIG. 2 illustrates a method of generating an interaction program in accordance with one embodiment of the present invention.

FIG. 3 illustrates a method of tracking an interaction program in accordance with one embodiment of the present invention.

FIGS. 4A-4J illustrates example user interfaces generated by a configurable element tracking program in accordance with one embodiment of the present invention.

FIG. 5 illustrates an example user interface generated for an end-user of a configurable element tracking program in accordance with one embodiment of the present invention.

FIG. 6 is a block diagram showing a mobile device that can be used in a cloud architecture in accordance with one embodiment of the present invention.

FIGS. 7-9 show examples of mobile devices.

FIG. 10 shows one example of a computing device that can be used in accordance with embodiments of the present invention.

While embodiments of the present invention are amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### SUMMARY

A configurable element tracking platform configured to provide an interaction indication is presented. The platform comprises a database configured to store a user (member) history for a user and an active interaction criteria. The platform also comprises user action analyzer logic configured to receive an indication of an action by the user and identify an action indication. The platform also comprises a data processing system configured to retrieve, using interaction retrieval logic, the interaction indication. The interaction indication comprises a criteria. The data processing system is further configured to, using interaction check logic, compare the action indication to the criteria and, if the action indication matches the criteria, generate a match indication, using interaction alerting logic.

### DETAILED DESCRIPTION

Reward and customer-retention programs have, over time, evolved to be more interesting, and difficult to track by a loyalty service provider. For example, some online retailers offer points-based programs, frequently running ‘double points’ or other increased bonus incentives for limited time ranges. One problem facing those interested in creating a customer-retention system is that the fixed software design requires significant upfront software coding and cost to implement, with no guarantee that the specific incentive selected for the fixed design will attract new or returning customers. Because of the different bases for incentives, including, but not limited to: redemptions, accruals, discounts, bonuses, promotions, communications etc., creating new and interesting programs is difficult and can be expensive. Additionally, tracking systems have to monitor a plurality of elements and features within points-based systems including point categorization, aging, bonuses, limited-time offers, elite tiers, member communication, segmentation, and other features. As used herein, points-based system is intended to include, but is not limited to, point tracking, miles/kilometers, segments, etc. Many users also want to view their history, including completed interactions, current progress, and, potentially, future options.

Loyalty programs have been traditionally designed for one specific industry, and are not appropriate or configured to support a different industry. Such programs track and act upon specific attributes of the industry, and the members' interaction with the program or company. For example, an airline may track a flyer's (member's) flight activity including the origin, destination, class of service, any connecting airports, etc., using a points-based system to track miles. Alternatively, a hotel may track a member's activity including property location, type of room, number of nights, hotel brand, type of spend, etc. Further, a supermarket may track a member's purchase activity, total amount spent, types of products purchased, response to sale items, etc.

A challenge of a service provider supporting a retention programs for companies in multiple industries is that trackable and actionable items of one industry may not match or even compare to trackable and actionable items of a different industry. For example, the number of nights stayed by a guest in a hotel is not equivalent to miles accrued in flights on a particularly airline.

For example, a hotel chain may want to implement a new loyalty program for returning customers—“stay 4 nights in any two hotels and get a 5^{th} night free.” Building out a system that tracks a number of nights a given person stays in one hotel, let alone one of a plurality of hotel chains, and detecting when the requirements have been met, presents a challenge. Additionally, getting such a system up and running is only good for the hotel industry. A software program that tracks ‘nights stayed in a hotel’ is tracking a commodity—nights—for example, that does not easily translate to companies in the airline or grocery business, for example. Therefore, if a tracking system could build out a system for the hotel industry to track nights stayed, using a fixed design system, it cannot use the same system for a new client in the retail industry. For the retail client, this also presents a disadvantage as the cost and time barriers to implementing a loyalty program cannot be reduced by modifying an existing system to fit their business.

One problem facing users of contemporary customer retention systems is the introduction of new incentives or modifications to existing programs. In order to track progress on a new item, significant changes are required to a platform software system and supporting data structures. Making the required changes may take significant programmer time, and result in a significant cost. Changes may be required for the underlying data model, data input and validation processes, data storage processes, program bonus and promotion processing, point categorization processing, point aging processing, member tier processing, point interaction processing, data extraction and export processing, as well as other associated features.

Contemporary Software-as-a-Service systems face significant maintenance and speed-related costs concerning management and control of different industries, different clients, and unique client or industry-specific modifications.

A tracking software platform is desired that provides a flexible and configurable solution configured to support loyalty programs for, and across, a plurality of industries. In one embodiment, the platform is configured to access a data storage system configured to store a series of rules that can apply either to a single industry or to multiple industries. The data storage system, in one embodiment, is also configured to store information regarding companies, their customers, customer habits, etc. In one embodiment, the configurable element tracking platform is provided as a Software-as-a-Service solution. In another embodiment, the configurable element tracking platform is configured to be installed and run as an application. In one embodiment, the system is configured to be accessible by multiple users, for example service provider administrative users and corporate users. In one embodiment, the system is also configured to be accessed by customer users, for example to track their earned rewards and progress to earned incentives.

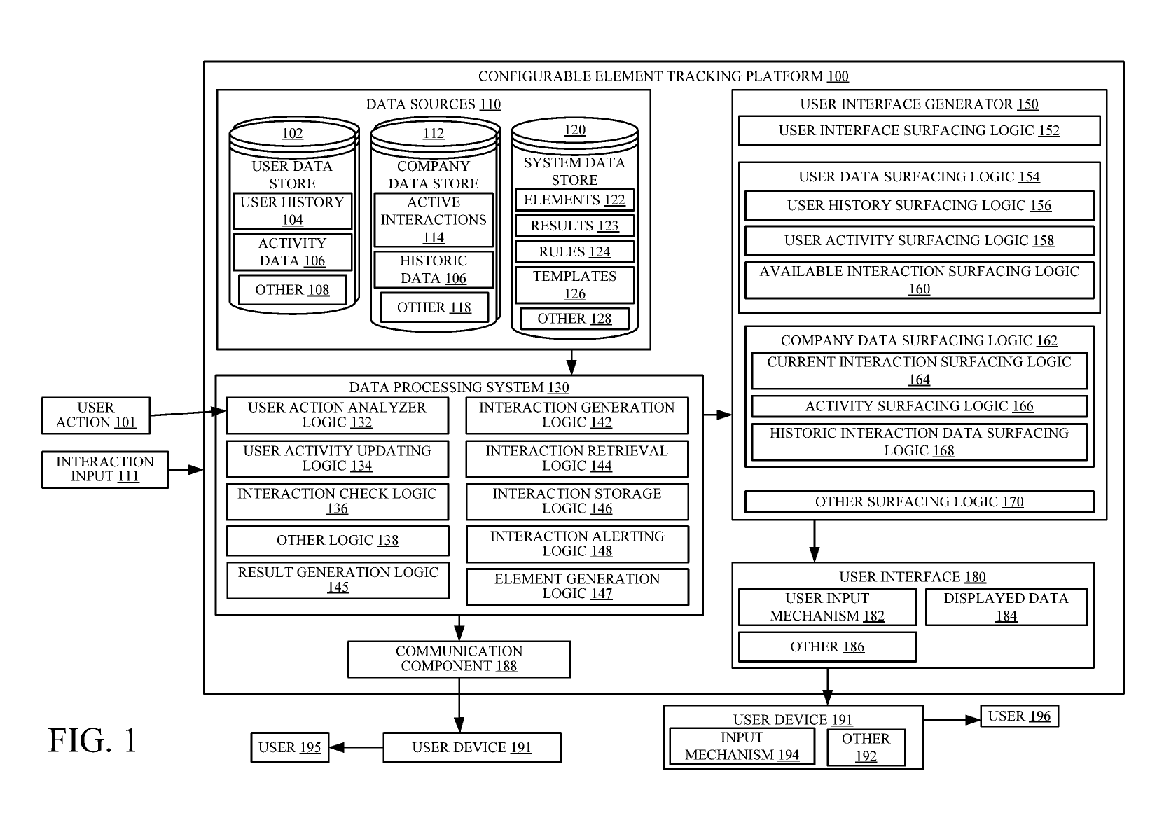

FIG. 1 illustrates a block diagram of a configurable element tracking platform in accordance with one embodiment of the present invention. It is desired for an interaction rule generation and tracking system to operate on a common core of software, such that any industry and any incentive can be mapped to a single software. This will reduce costs to a system administrator, who will no longer need to build out individual solutions for individual clients. It will also reduce costs to corporate customers, and increase the speed at which new interaction initiatives can be introduced or tested, and old ones modified. Additionally, updating a single common core software is easier, faster, and less expensive than updating a plurality of software services, each for a different customer. The configurable element tracking platform 100, described in FIG. 1, provides such a user-configurable system.

Using configurable element tracking platform 100, a company can quickly set up and offer new interaction-based programs, and change existing interaction-based program parameters quickly in response to customer or other feedback. An interaction-based program, for example, tracks a user's interactions with a company, for example purchasing products and earning points, miles earned while on a flight, etc. The flexibility of configurable element tracking system 100, in one embodiment, is achieved by operating on a combination of program logic and a data model that allows all relevant variables to be addressed and labeled as elements. Different elements are applicable, and selectable, for different industries and different clients. This allows for significant changes to be made to a specific offering (for example, for Airline A's program) without the need for software coding changes to the overall configurable element tracking platform 100.

Configurable element tracking platform 100 comprises a plurality of data sources 110. While three distinct data stores are illustrated in FIG. 1, it is understood that data accessed by platform 100 can be spread across more, or fewer, data stores than those illustrated.

Configurable element tracking platform 100, in one embodiment, retrieves individual user data from a user data store 102. For example, a consumer associated with an interaction program may need activity tracked over time to satisfy an interaction rule. For example, a user may earn “one night free” after staying in a hotel three different times, or three different hotels once. Therefore, user history 104 may be retrievable by platform 100. Additionally, a user's current activity data 106 can also be retrieved. For example, an indication of a user checking into a hotel for the fourth time may comprise activity data 100. Other information 106 can also be stored in association with an individual user. For example, a user may have a previous interaction history stored within user data store 102. A user may also be associated with different member roles, in one embodiment. For example, many airlines have member tiers based on past activity. Many other retailers offer member-specific benefits. In one embodiment, configurable element tracking platform 100 is configured to store, and make decisions, for example in user data store, indications of a user's member status.

Configurable element tracking platform 100, in one embodiment, retrieves data from a company data store 112. Different companies, in different industries may require different interaction rules. Company data store 112 may, therefore, contain different data based on a relevant industry. Data store 112 may comprise, in one embodiment, active interaction information 114 for currently active interaction rules. Additionally, company data store 112 may also comprise historical data 116, for example associated with past interaction rules. Historical data 116 may also comprise interaction rates for past interaction rules. For example, a previous interaction rule may have achieved 5% participation among a desired user base. Company data store 112 may also comprise other data 118.

Configurable element tracking platform 100 may also comprise a system data store 120. System data store 120 may comprise a plurality of elements 122, some of which are configured to apply across a plurality of industries, and some that are industry-specific. Some examples of elements that may be defined by a given company/industry include: extending the definition of member, member tier information, accrual factors, qualifying transaction/interaction information, bonus and promotion rules, redemption rules, interaction rules, point categorization rules, point expiration rules, elite tier classifications, interaction rules, content (CMS) rules, etc. In one embodiment, platform 100 is configured to add or remove elements as new interaction rules are designed. Use of elements 122, in combination with data definitions and logic rules, allow for significant cost savings over traditional offerings, and substantially increase the speed to market and efficiencies in updating or modifying incentives programs.

System data store 120 may also comprise a plurality of results 123, achieved by users upon satisfaction of a selected element 122. For example, an element may comprise purchasing gas, and a result may comprise ‘ten cents off per gallon’ at a designated store.

System data store 120 may also comprise a plurality of interaction rules 124. In one embodiment, an interaction rule 124 provides a designated result 123 based completion of one or more definable elements 122, such that a user can generate an interaction rule 124 using platform 100 by pairing one or more results 123 with one or more elements. As a simplified example presented for illustration only, a rule may comprise “Buy four blue shirts, get one free.” The item of interest in this example may be a single item, for example ‘night’ in the hotel industry, or it may be a dollar value, for example ‘ten cents off per gallon of gas at your next fill up.’

System data store 120 may comprise a plurality of previously-created templates 126, which can be used as the basis for a new interaction program. While a single interaction rule has been described thus far, it is to be understood that many retention programs comprise a plurality of elements 122 which, when satisfied, provide one or more alternative results 123. System data store 120 can also comprise other information 128.

As an example, interaction rules 124 may be used in conjunction with elements 122 and results 123 to define and enhance a plurality of actions used as the basis for many programs, including some or all of: new member enrollment, accrual processing, bonus processing, promotion processing, point categorization process, point aging processing, member tier processing, redemption processing, interaction processing, content delivery, offer deliver. In one embodiment, accrual processing may comprise any of online processing, API processing, or batch load processing.

In one embodiment, platform 100 is configured to support multi-currency and interaction-based tracking by providing a number of definitions for a currency element 122. In one embodiment, platform 122 is configured to support multiple formats for interaction rules 124, for example through a plurality of templates 126 as well as the ability for a user to create a new configuration. In one embodiment, configurable element tracking platform 100 is also configured to provide operational and trend reports, for example based on stored information within databases 102, 112 and 120. In one embodiment, platform 100 is configured to provide integration between a company associated with data store 112 and, for example, a call center and/or a rewards partner. In one embodiment, platform 100 is configured to support real-time point-of-sale integration. In one embodiment, platform 100 is configured to provide Business-to-Business-to-Consumer (B2B2C) capabilities through a B2B2C portal. In one embodiment, platform 100 is configured to integrate with one or more social media platforms.

In one embodiment, databases 102, 112 and 120 are searchable by keyword/filter/industry-specific rules or items, etc. A user setting up a new incentive program, or modifying an existing one may, using a user interface, access system database 120 and retrieve an interaction rule 124, result 123 and/or element 122 for further definition. New elements 122 within platform 100 can thus be created and defined on demand.

In one embodiment, configurable element tracking platform 100 comprises a data processing system 130 configured to receive a user action 101 and/or an interaction input 111. In response to receiving a user action 101, for example, data processing system 130 is configured to retrieve and track user history 104 and provide an indication when an interaction rule 124 is satisfied. In response to receiving an interaction input 111, for example, data processing system 130 may be configured to generate a new interaction rule 124, modify an existing interaction rule 124, or otherwise assist a user in generating a new interaction program.

In response to a received user action 101, data processing system 130 can, using user action analyzer logic 132, parse user action 101 for user activity data 106. User activity updating logic 134, in one embodiment, is configured to update user history 104, and activity data 106 with the received user action 101. Additionally, data processing system 130 may be configured to, using interaction check logic 136, determine whether the user action 101 meets an element 122 of an existing interaction rule 124, retrieved from data sources 110 using interaction retrieval logic 146, in one embodiment. For example, if a retailer has a current promotion of 10% off a purchase of $50 or more, a user action 101 comprising a purchase of $49.99 may cause data processing system 130 to automatically, using interaction check logic 136, automatically determine that the noted interaction rule is not met and not provide the discount. Or, in another example, awarding ten points with a qualifying purchase, e.g. 10 blue shirts or a purchase over $50. If, instead, the purchase was for $50.01, interaction check logic 136 may automatically indicate, for example using interaction alerting logic 148, that an interaction rule has been met. Automatically alerting, using interaction alerting logic 148, may comprise automatically reducing the purchase price by $5.00. Alternatively, or in addition, automatically alerting may comprise providing an indication, to either the purchaser, the seller, or a third party, that the interaction rule was met. While the previous example described a price-based element 122 and a discount-based result 123, it is to be understood that platform 100 is configured to provide a plurality of different elements 122 and results 123 that cover a wide range of interactions.

In response to a received interaction input 101, data processing system 130 may assist in the creating of a new interaction rule 124, or modification of an existing interaction rule 124. For example, interaction retrieval logic 144 may be configured, in one embodiment, to retrieve one or more existing interaction rules 124, templates 126, elements 122 and/or results 123. A user can, using a user interface 180, define elements 122 and results 123 for a new interaction rule 124, or alter elements 122 and results 123 for an existing rule. For example, an interaction input 111 may comprise an instruction to change a purchase element 122 from a ‘shirt’ to a ‘sweater’ using element generation logic 147. Alternatively, element generation logic 147 can be used to generate an element 122 not currently present within system data store 120. Additionally, an interaction input 111 may comprise an instruction to change a result 122 from ‘10% off’ to “$10 off,” or extra points for example, using result generation logic 145.

Interaction generation logic 142 may, in one embodiment, assist a user in the process of creating a new interaction program comprising one or more interaction rules 124, or modifying an existing interaction program. Once generated, interaction storage logic 146 is configured, in one embodiment, to store the interaction program within company data store 112 such that it is retrievable by interaction retrieval logic 144 in response to a user action 101.

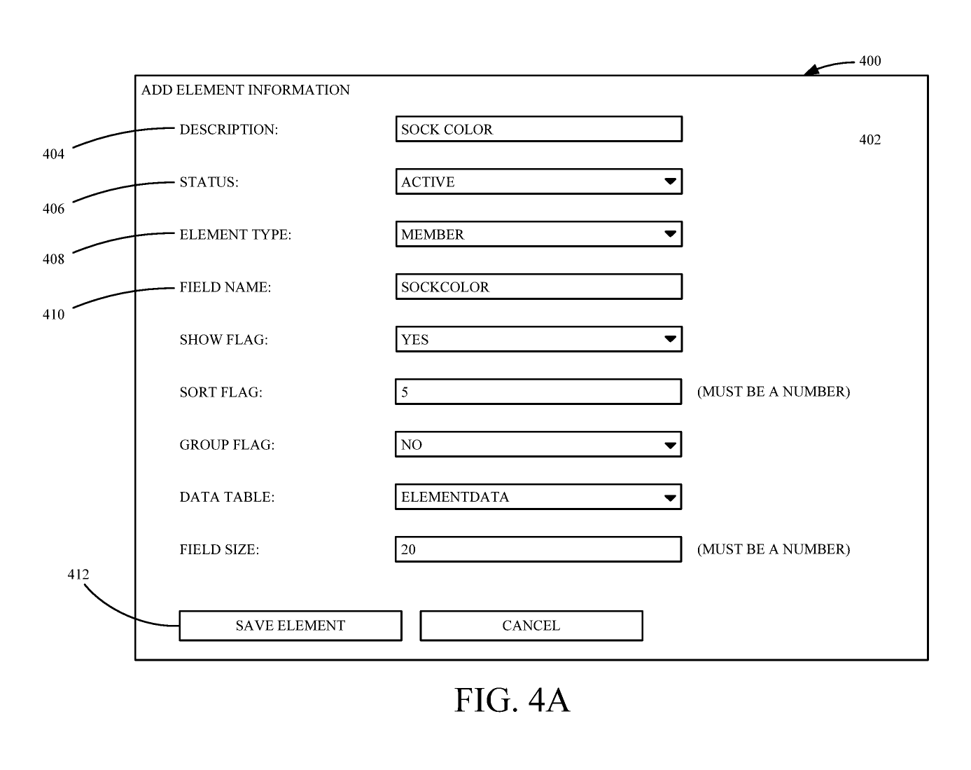

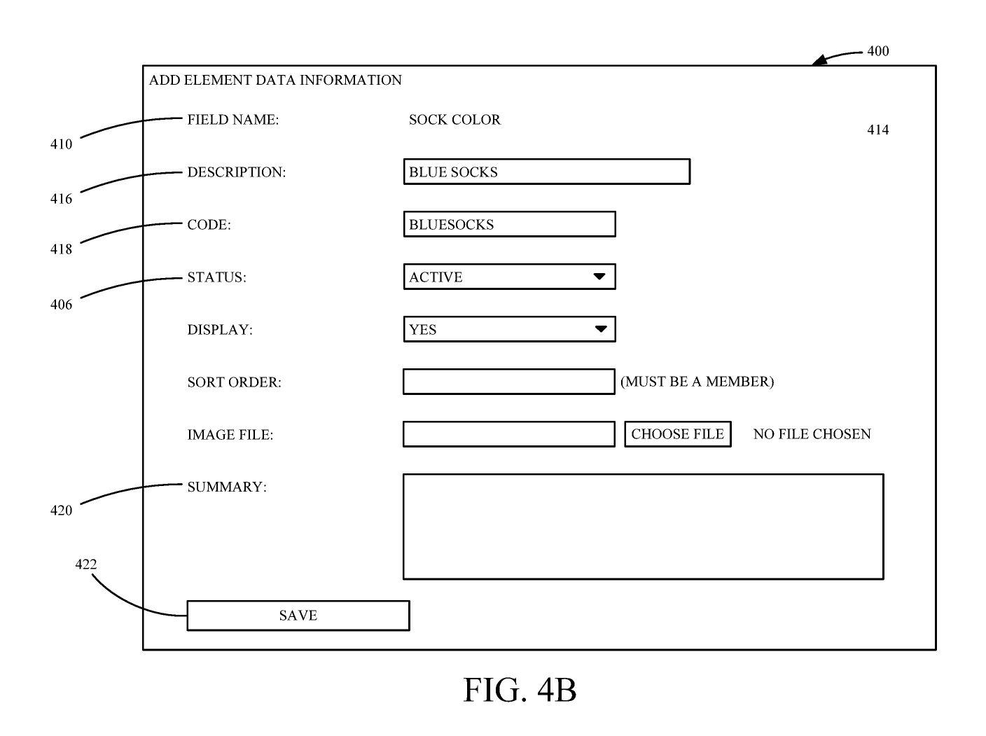

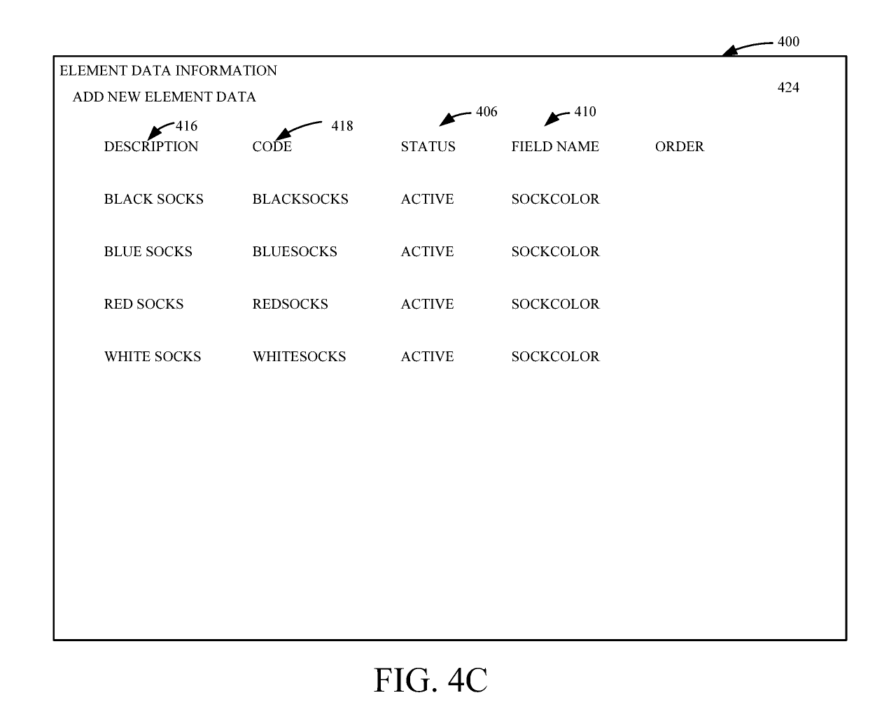

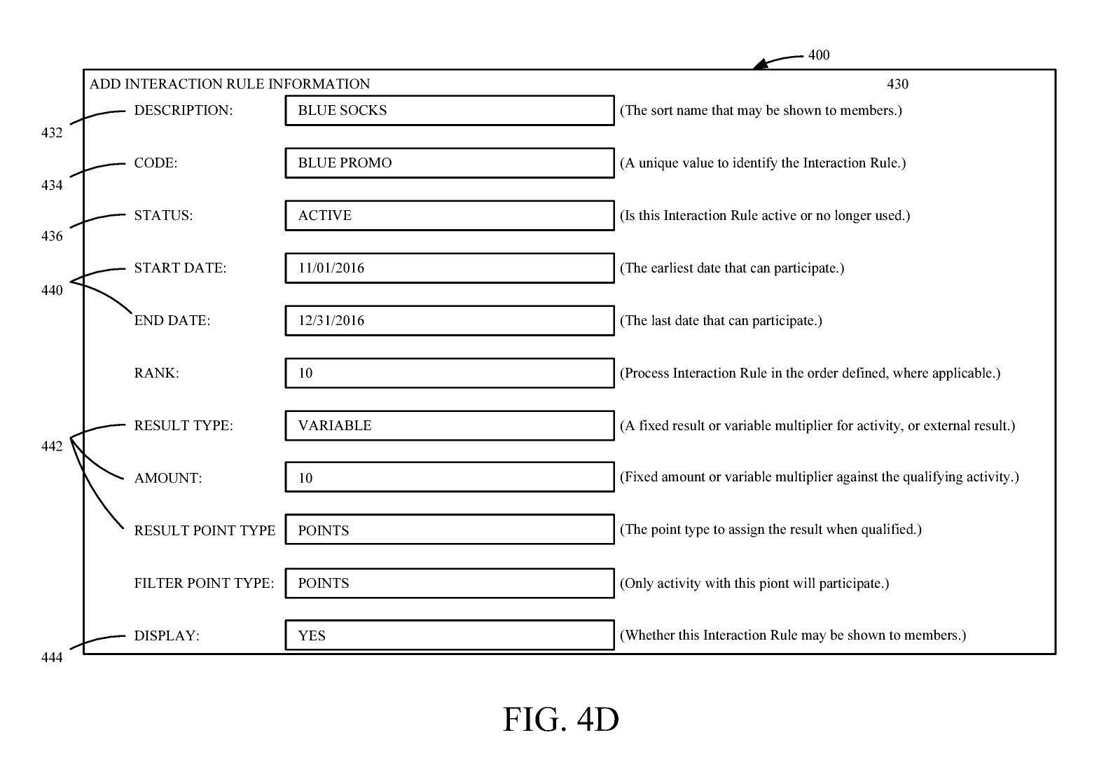

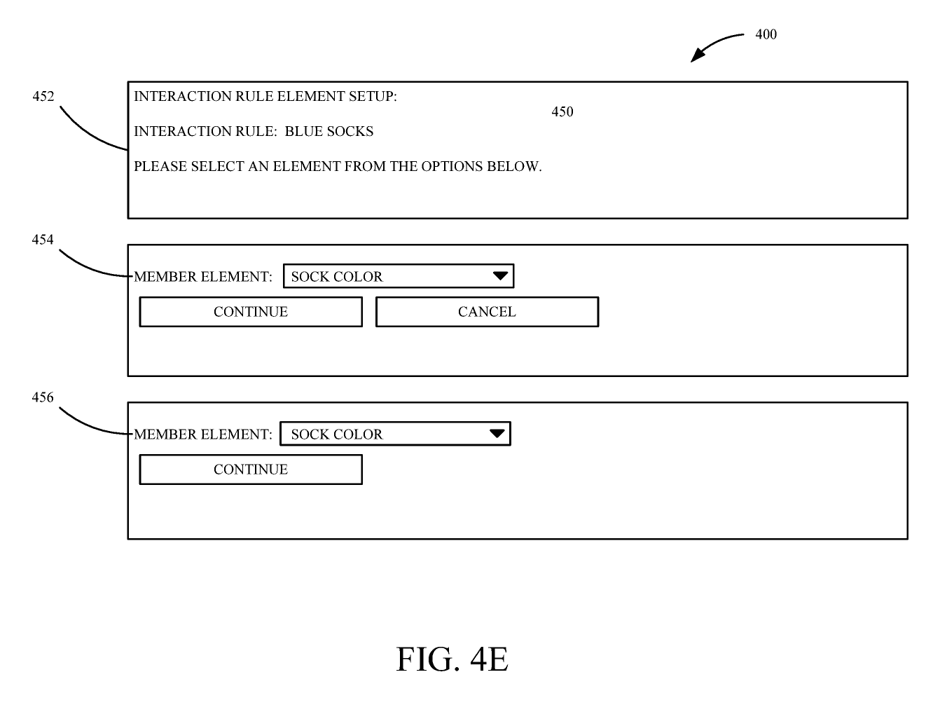

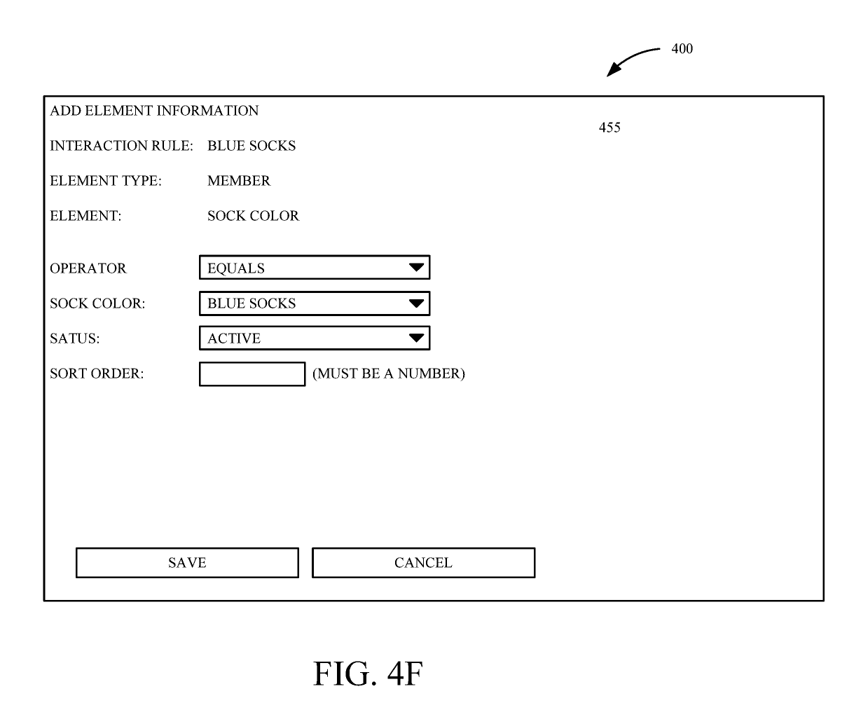

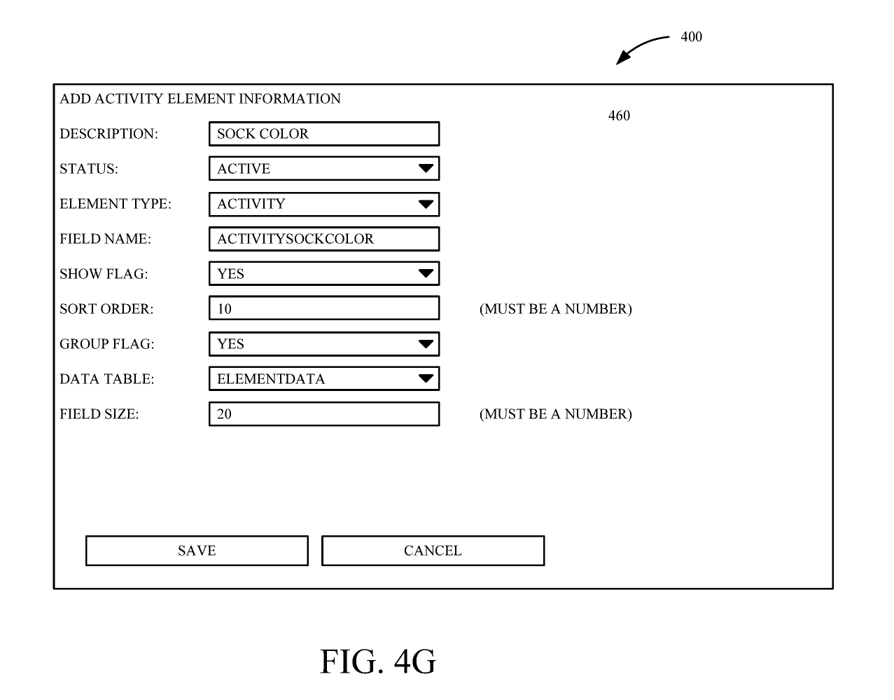

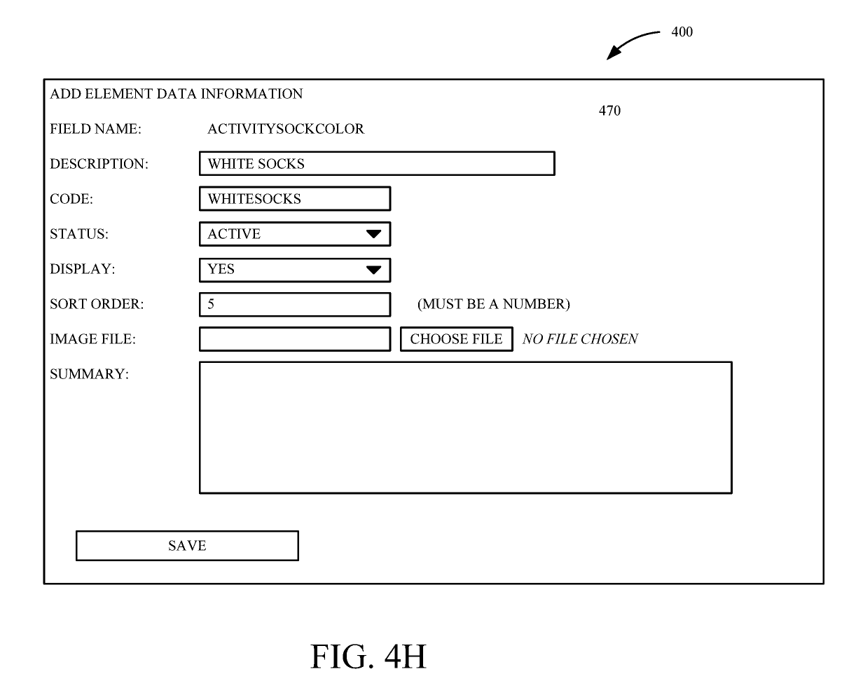

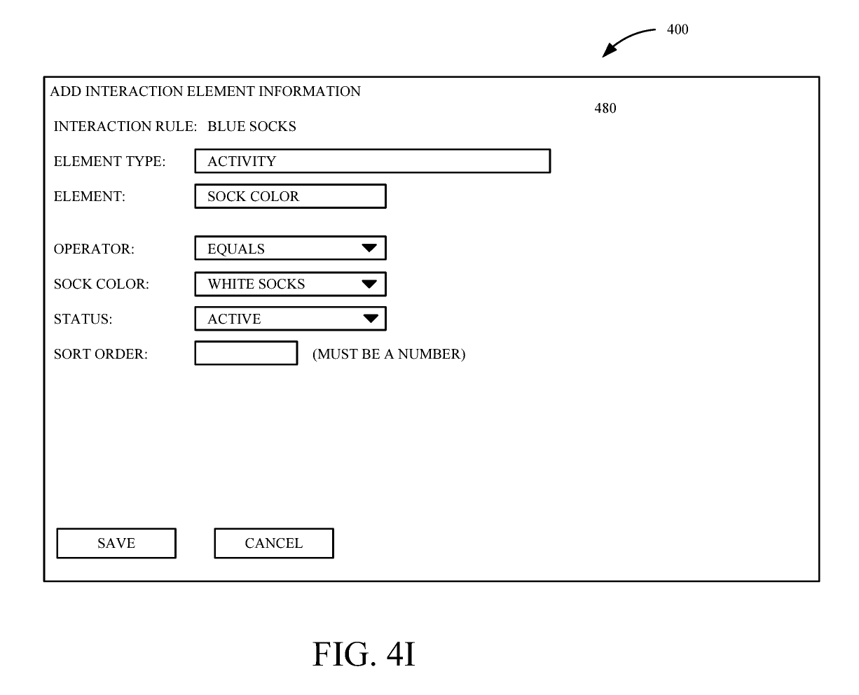

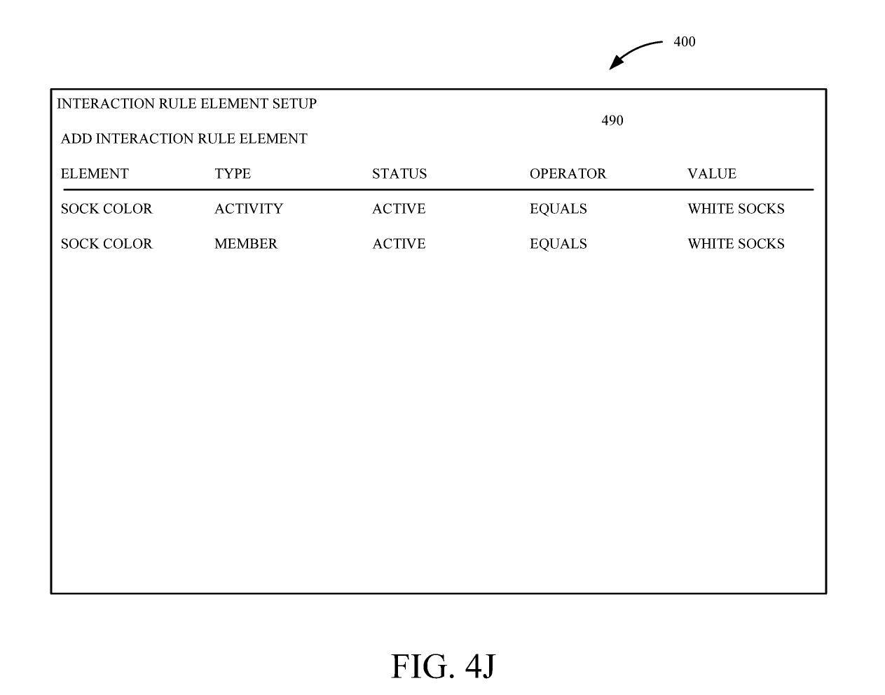

User interface generator 150, using user interface surfacing logic 152, is configured to generate a user interface for use by a user 196 interacting with a device 190. User 196, in one embodiment, is an administrator interacting with user interface 180 in order to generate a new interaction rule 124, an example of which is illustrated in FIGS. 4A-4J, presented below. In another embodiment, user 196 is a consumer interacting with an application tracking earned rewards and incentives.

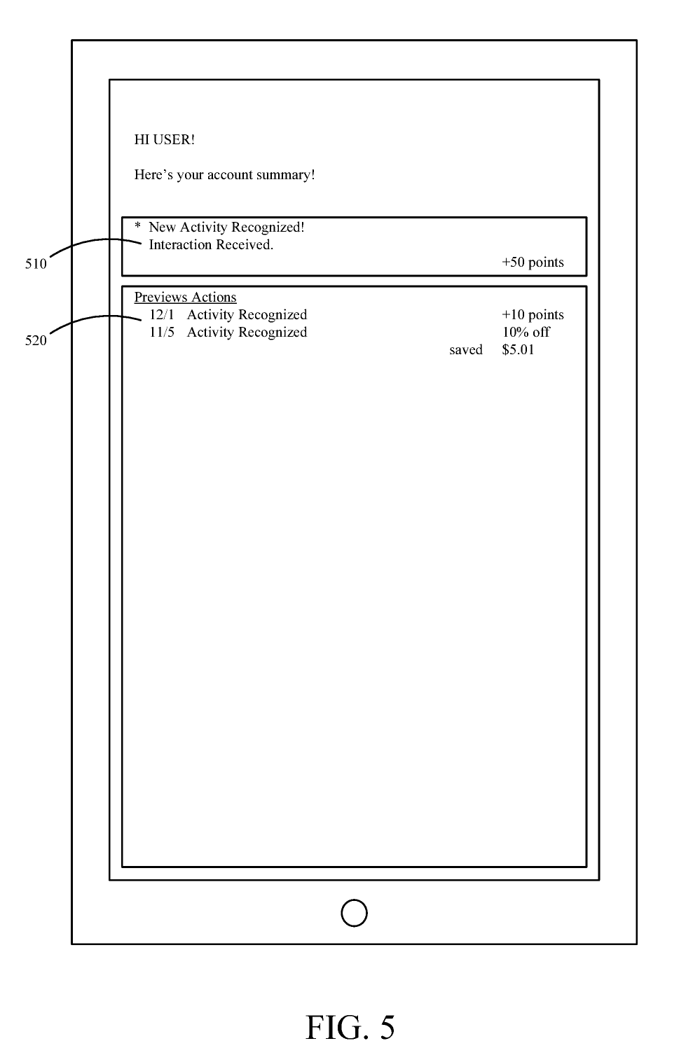

User interface generator 150 is configured to surface a plurality of metrics. In the embodiment where user 196 is a consumer, user data surfacing logic 154 is configured to surface a user interface 180, for example that described with respect to FIG. 5. For example, user history 104 can be surfaced using user history surfacing logic 156. User activity data 106 can be surfaced using user activity surfacing logic 158. Additionally, information regarding active interactions 114 can be surfaced using available interaction surfacing logic 160. Additionally, other surfacing logic 170 may, in some embodiments, provide additional information such as user account information.

User interface generator 150, in the embodiment where user 196 is a company interested in creating or modifying an interaction program, is configured to surface information regarding current/past interaction programs and interaction rules 124. For example, company data surfacing logic 162 is configured to retrieve information from company data store 112. In one embodiment, current interaction surfacing logic 164 is configured to retrieve active interaction information 114. Additionally, activity surfacing logic 166, in one embodiment, is configured to surface information regarding current interaction rules. For example, activity surfacing logic 166 may retrieve and surface data regarding the success, or participation level, of a current promotion. For example, an indication of inventory levels of giveaway items may be presented, or a total amount discounted, or a number of individuals satisfying an element 122 of an interaction rule 124, or another indication. Such information may be helpful, for example, in deciding whether to extend, or repeat a temporary interaction rule. In one embodiment, historic interaction data surfacing logic 168 is configured to retrieve historic activity data 116 for a current, or a previously offered, interaction rule 124. Additionally, other surfacing logic 170 may, in some embodiments, provide additional information.

User interface 180, in addition to displaying data 184 surfaced by user interface generator 150 and surfacing logic 152, may comprise other functionality 186. User interface 180 may also comprise one or more user input mechanisms 182. Some example user interfaces are described with respect to FIGS. 4-5, discussed in greater detail below.

User device 190, in one embodiment, comprises a computing device such as a desktop or laptop computer, smartphone, tablet, PDA, etc. User device 190, in one embodiment, comprises one or more user input mechanisms 194, through which user input indications are received from user 196. User device 190 may also comprise other functionality 192.

In one embodiment, configurable element tracking platform 100, in addition to providing business-to-business services in creating new interaction programs, is also configured to support business-to-customer interactions. For example, many companies with rewards programs control said programs through interactive websites and/or applications. In such an embodiment, platform 100 comprises a communication component 188 configured to communicate interaction indications to a user device 191. For example, in response to detecting that a user 195 has satisfied an element 122 for a rule 124, communication component 188 may provide an indication that a result 123 has been achieved. In a points-based system, such an indication may comprise an electronic message indicating a number of points earned. In another embodiment, a discount is communicated by communication component 188. Communication component 188 may communicate using any appropriate mechanism, including, but not limited to: in-app messaging, SMS messaging, e-mail messaging, social media etc.

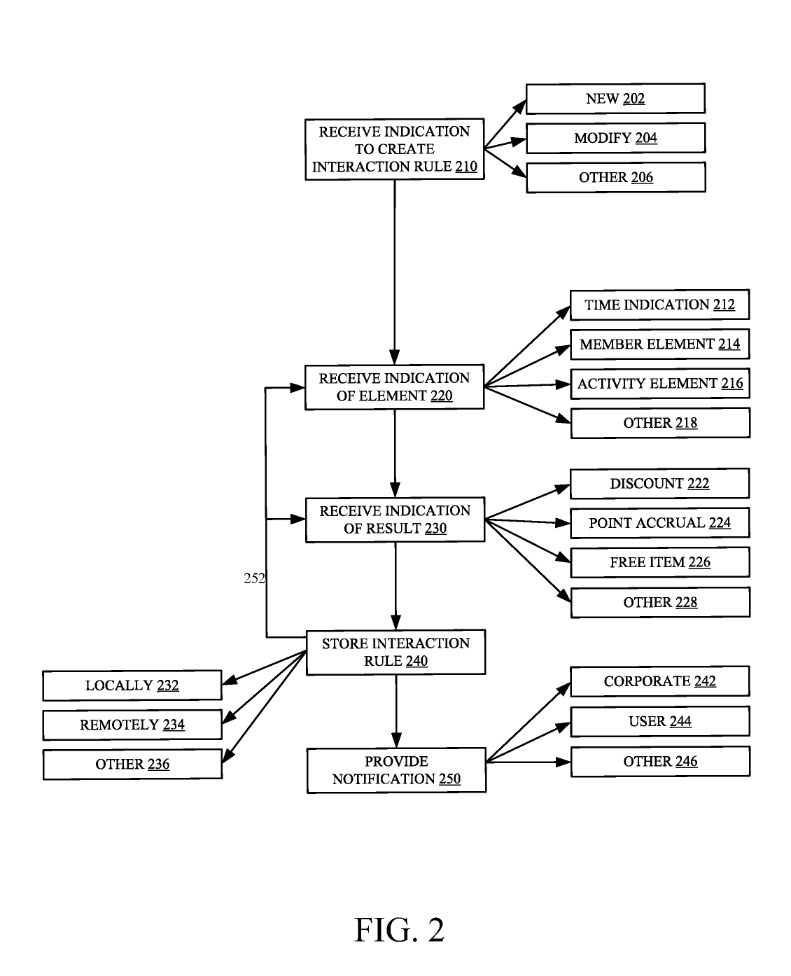

FIG. 2 illustrates a method of generating an interaction program in accordance with one embodiment of the present invention. Method 200, in one embodiment, allows a user of configurable element tracking platform 100 to create a user-configurable interaction rule 124.

At block 210, an indication to create an interaction rule is received. For example, an interaction input 111 is received, and parsed by user action analyzer logic 132. In one embodiment, the indication comprises an indication to create a new interaction rule, as indicated in block 202. In such an embodiment, a new interaction rule is generated using interaction generation logic 142. In another embodiment, the indication comprises an indication to modify an existing interaction rule, as indicated in block 204. In such an embodiment, interaction retrieval logic 144 is configured to retrieve an interaction rule 124 for editing. Other interaction rules may also be retrieved or generated by data processing system 130, as indicated in block 206.

At block 220, an indication of an element is received. The element can comprise, in one embodiment, a time indication, as indicated in block 212. A time indication can comprise, for example, a start date and/or time, an end date and/or time, a time period, or a combination thereof, for example starting on Jan. 1, 2017 and lasting for two weeks. An element 122 can also comprise a member element, as indicated in block 214. For example, a points-based interaction system may comprise a member element—e.g. all stockholders of record on a dividend date, for example, or all members with a minimum number of miles, or elite tier, or any other suitable member classification. However, in another embodiment, an element 122 can comprise an activity element, as indicated in block 216, e.g. any purchase of $50.00 results in a $5 credit or points. Other elements 122 are also envisioned, as indicated on block 218. Additionally, combinations of elements are also envisioned. For example, a rewards member who makes a specific purchase on a given day may satisfy each of a member element, a time element, and an activity element.

At block 230, an indication of a result is received. For example, a result 123 can comprise a discount to be applied at the time of purchase, as indicated in block 222. In another embodiment, a result 123 comprises an accrual of points, as indicated in block 224. Additionally, a result can comprise a free item, as indicated in block 226. Other potential results are also envisioned, as indicated in block 228. For example, a future discount, a one-time point bonus, or any other desired result 123 specified and defined by a user within platform 100. Newly defined results 123 can be stored in system data store 120, or within company data store 112.

At block 240, the interaction rule is stored. In one embodiment, as indicated by arrow 252, an interaction program comprises multiple elements and/or multiple results, and is not complete until all elements 122/results 123 are defined. For example, only a purchase within a specific time frame, or only a qualifying purchase by a member will result in all elements being satisfied. For such an interaction rule 124, the steps outlined in blocks 220 and/or 230 may repeat until a user is satisfied with the resulting interaction rule. Once an interaction rule 124 is complete, it is stored by platform 100 for later retrieval—for example by interaction check logic 136. In one embodiment, interaction rules 124 are stored locally, as indicated in block 232. In another embodiment, interaction rules 124 are stored remotely, as indicated in block 234. Interaction rules 124 can also be stored and accessed in other configurations, as indicated in block 236.

Interaction rules 124 can be stored in system data store 120, in one embodiment, for later retrieval activation. In one embodiment, interaction rules 124, interaction rules 124 are stored as active interactions 114, or as historic data 116, within a company data store 112. In one embodiment, when stored, interaction rules 124 are not immediately activated such that elements 122 are available for satisfaction.

At block 250, a notification is provided. In one embodiment, a notification is provided when an interaction rule 124 is created. In another embodiment, a notification is provided when an interaction rule 124 is active. Providing a notification, in one embodiment, comprises providing a notification to a corporate user that the interaction rule is available and/or active, as indicated in block 242. In another embodiment, providing a notification comprises providing a notification to a user that a new interaction rule 124 is available, with elements for satisfaction, as indicated in block 244. Other notification configurations are also envisioned, as indicated by block 246. For example, notifications can be provided using communication component 188.

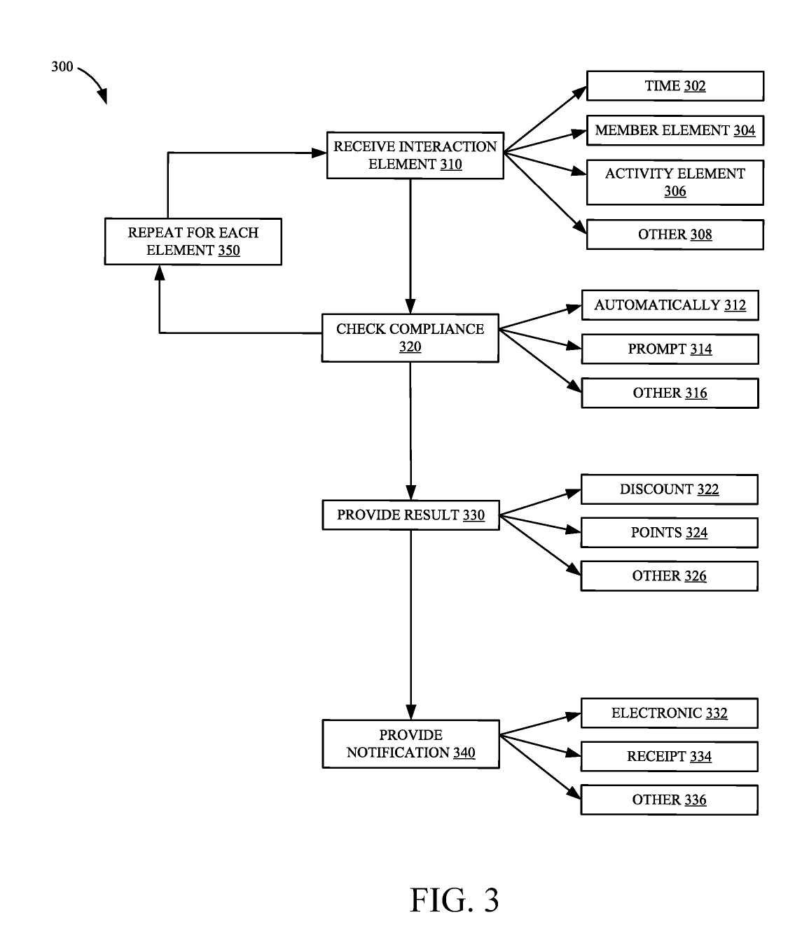

FIG. 3 illustrates a method of tracking an interaction program in accordance with one embodiment of the present invention. Method 300 may be useful, for example, by a business or third-party tracking compliance with one or more interaction rules 124. For example, a successful interaction program can be measured in a variety of ways besides increased sales. Increased user activity, and compliance with one or more criteria is also important. For example, an interaction program may offer a first interaction rule 124 for a small purchase (e.g. $5 off a $20 purchase) and a second interaction rule 124 for a larger purchase (e.g. $15 off a $50 purchase). Understanding how often each of the first and second interaction rules are satisfied can be helpful for understanding customer interests, gauging program cost effectiveness, and designing future promotions.

At block 310, an interaction element is received. For example, interaction retrieval logic 144, in response to a user action 101, may retrieve all active interaction rules 124 from company data store 112. Each interaction rule 124 can be parsed for elements that may be satisfied by user action 101. For example, a time element 122 may be identified, as indicated in block 302. A member element 122 can also be identified, in one embodiment, as indicated in block 304. In another embodiment, an activity element 122 can be identified, as indicated in block 306. Other elements 122 can also be identified, as indicated in block 308.

At block 320, compliance with an identified element in checked. For example, in one embodiment, user action 101 is parsed for user activity in block 132. Identified user activity is checked against an identified interaction rule element 122 by interaction check logic 136. Compliance may be checked, in one embodiment, automatically, as indicated in block 312. For example, data processing system 130 may retrieve user membership data from user data store or company data store and automatically identify a user as satisfying a membership criteria. In another embodiment, compliance may be prompted, as indicated in block 314. For example, a prompt might appear on a cashier display indicating that that cashier should ask if the user is a member of the program. Other compliance mechanisms are also possible, as indicated in block 316.

At block 350, compliance is checked for each element 122 for a given interaction rule 124. This step may be repeated for each element of each identified interaction rule 124.

At block 330, a result is provided. In one embodiment, a result 123 is provided automatically. For example, in the embodiment where the result is a discount, as indicated in block 322, automatically providing the result comprises automatically deducting the specified discount once all elements are satisfied. In another embedment, the result comprises a points accrual. However, other resulting scenarios 123 are also envisioned, as indicated in block 326.

At block 340, a notification is provided. For example, in one embodiment, a notification is provided on user interface 180 indicating that an interaction rule 124 was satisfied. In another embodiment, an indication of a satisfied interaction rule 124 is provided through communication component 188 to user device 191. The notification can be provided electronically (e.g. via e-mail, SMS, in-application messaging or other electronic communication configuration), as indicated in block 332. The notification can also be provided on a copy of a receipt provided to a user, as indicated in block 334. Other notification mechanisms are also possible, as indicated in block 336.

FIGS. 4A-J illustrate example user interfaces generated by a configurable element tracking program in accordance with one embodiment of the present invention. In one embodiment, configurable element tracking platform 100 is configured to provide access to an interaction program generator through user interface 400, for example. While interface 400 is illustrated on a tablet interface, it may be accessible on a web browser, through an application, or through another appropriate software interface. In one embodiment, platform 100 is configured to provide customer tier information, segmentation and scoring. In one embodiment, platform 100 is configured to provide connectivity, for example through e-mail, text, mobile or other appropriate communication mechanism, for example using communication component 188. In one embodiment, platform 100 is configured to provide multi-brand and sub-club flexibility. In one embodiment platform 100 is configured to generate and allow interaction through user interfaces 400, illustrated in FIGS. 4A-4J, or another suitable interface designed to accommodate user-friendly administration and account management functions.

In one embodiment, configurable element tracking platform 100 is configured to provide a user with one or more potential templates from which to build a new interaction program. For example, detecting that a user is a user in the hospitality industry, configurable element tracking platform 100 may, in one embodiment, provide a base template suitable for a hospitality-based company. In one embodiment, the base template comprises a series of logic rules 124, elements 122, and results 123 applicable to the industry of interest. In another embodiment, the base template comprises a series of general logic rules and elements applicable to a plurality of industries of interest. In one embodiment, the base template is configured such that a user can add or remove proposed logic rules and/or elements through an intuitive user interface. In another embodiment, an interaction program comprises tools configured to allow for a user to create all, or substantially all, of their desired interaction rules 124 comprising relevant result 123 and element 122 combinations. Each of these creations and modifications, in one embodiment, can be handled by the element architecture, such that software professionals are not required to provide the implementation.

FIGS. 4A-4J illustrate one example of dynamically adding new elements 122 and results 123 to an interaction program. While the example of a fictitious retailer providing a sock promotion is presented as a simple illustration, it is to be understood that embodiments and methods described herein allow for a broad range of interaction rules 124, ranging from simple to complex. In the example provided in FIGS. 4A-4J, a retail company is generating a sock-based interaction rule 124 where points are earned for members that currently owns blue socks and purchases white socks. Owning blue socks is an example of a member element, and purchasing white socks is an example of an activity element. Using a traditional set-up, creating such an interaction rule 124 would require hundreds of hours of development time. Using platform 100, as illustrated in user interfaces 400 of FIGS. 4A-4J, such an interaction rule 124 can be generated in a few minutes. Such flexibility allows businesses using platform 100 to dynamically change and update interaction rules 124 in response to changing demand and changing market scenarios.

FIG. 4A illustrates a user interface 400 presenting an element information view 402. A user can enter description information 404 for an element 122, delineate whether an element 122 is active, indicate whether element 122 is a member element or activity element by changing an element type 408. Additionally, the user may add a name 410 for the element. Newly-generated elements can be saved using save icon 412, for example, and may be stored either in company database 112 and/or system data store 120. In the illustrated example, a user is shown generating a new member element.

In FIG. 4B, the user may be prompted to add additional detail on a detail screen 414 defining the member element 122 created in FIG. 4A. A description 416 can be added, and a more specific codename 418 can be defined. Additionally, user interface 400 may provide a summary section 420 for adding additional details. A user can save newly-added details using save icon 422.

In FIG. 4C, a user can review element data using a screen 424. For example, while a current promotion may recognize a user wearing blue socks, it may be desired to later switch to recognize users wearing white socks. Element descriptions 416 may be presented, along with codenames 418, a status 406 and field name 410.

Once elements are defined, a new interaction rule 124 can be generated, for example using interaction rule screen 430 illustrated in FIG. 4D. Interaction rule 124 can be assigned a name 432, for example for easy retrieval later by interaction retrieval logic 144. A code name 434 can be assigned to interaction rule 124, and a status 434 can be selected. Time indications 440 can be entered. For example, a start date and an end date, as indicated in FIG. 4D, or, in another example, a start date with an open end date. Other options are also envisioned. Interaction rule screen 430 can also allow for entry of results 123, for example by selecting and entering result options 442. Once generated, interaction rule 124 can be displayed to members using display option 444. In one embodiment, displaying interaction rule 124 comprises using communication component 188 to communicate an indication of active interaction rules 124 to user devices 191, for example using e-mail, SMS, in-application messaging, or any other suitable communication mechanism.

FIG. 4E illustrates another interaction rule setup screen 450. A user can, for example, use screen 450 to edit an existing interaction rule 452. The Blue Socks interaction rule has been selected for modification. A user can, for example, alter either or both of an activity element 456 or a member element 454. As an example, member element 454 was selected in FIG. 4E. FIG. 4F illustrates a subsequent element editing screen 455. For example, using screen 455, a sock color satisfying member element 122 for the Blue Socks interaction rule could be easily changed to red, for example, using interface 400.

FIG. 4G illustrates an activity element details screen 460, presented on user interface 400, for example. Additional details can be entered on activity element screen 470 and 480, presented in FIGS. 4H and 4I. One example of a summary of elements 122 present in interaction rule 124 is presented in FIG. 4J.

FIG. 5 illustrates an example user interface generated for an end-user of a configurable element tracking program in accordance with one embodiment of the present invention. For example, in some embodiments, platform 100 is useful for both managing setup of interaction rules 124 as well as tracking user interactions. Communications to customer-users can be provided, for example by communication component 188, in a variety of ways. In one example, a user account summary view 502 is presented on a device 500. However, website-based communication, as well as electronic communication (e.g. SMS messaging, mobile, e-mail, social media, etc.) are also envisioned. Additionally, platform 100 may be configured to support interaction data on an application.

User account summary view 502 may provide indications of new activity 510 and previous activity 520. For example, a points-based interaction rule 124 may provide points for different member and activity elements 122. However, other interaction rules 124 may also be available. As illustrated in FIG. 5, a user has new activity comprising a points reward, and previous activity comprising a discount applied.

In one embodiment, configurable element tracking platform 100 is configured to be built into a company's interface, for example so the company can act as administrator and control the database. In another embodiment, platform 100 is configured to be hosted by a third party, such that the database is housed separate from a company user. In another embodiment, the company user may house at least a portion of the data accessible by the platform 100, for example based on security concerns or regulatory concerns.

In one embodiment, platform 100 is configured to provide controls against fraud, for example through integrated security measures such as passwords, multi-point authentication, recognized devices or another appropriate security mechanism.

Some advantages of some embodiments described herein, as compared to conventional incentive programs is that the selection of elements 122, results 123 and rules 124, independent of industry, allows for a quick-to-market solution that matches the needs of a company without software professional intervention. The option to custom define elements 122 may also allow for increased innovation in product offerings, as companies can think outside of their traditional offering constraints. Should a company select an option that does not result in increased customer interaction or increased profits, at least some embodiments described herein allow for rapid modification of an existing program. At least some customers appreciate companies responding to their views and opinions, and may positively react to an interaction program that is customized and updated frequently.

In some embodiments, a company may use configurable element tracking platform 100 to offer customers a choice, for example a credit card company may customers the option of receiving cash back or converting reward points to miles, for example to use toward an airline ticket purchase.

In some embodiments, configurable element tracking platform 100 is data driven and configured to provide metrics regarding a designed given interaction program's effectiveness for both a company and its customers. In one embodiment, this comprises use of customer feedback to generate recommendations for further customization. In one embodiment, customer feedback for a given industry is provided to a new customer, or in conjunction with a selected interaction rule 124, element 122, or result 123, such that a new customer can benefit from insights and analysis collected by the provider of platform 100.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

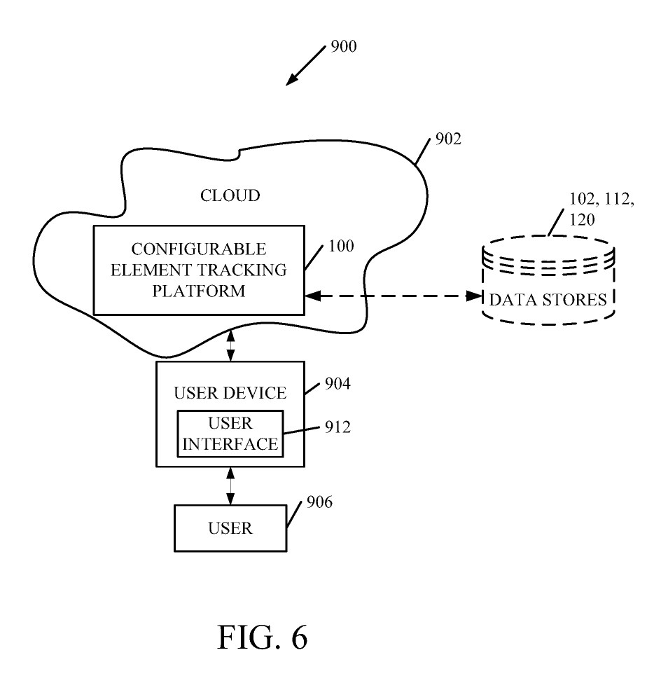

FIG. 6 is a block diagram of a configurable element tracking platform 100 described with respect to FIG. 1, except that its elements are disposed in a cloud computing architecture 900. Cloud computing provides computation, software, data access and storage services that do not require end user knowledge of the physical location or configuration of the system that delivers the services. In various embodiments, cloud computing delivers the services over a wide area network, such as the Internet, using appropriate protocols. For instance, cloud computing providers deliver applications over a wide area network such that they can be accessed through a web browser or other computing component. Software or components of data processing system 130 of platform 100 as well as the corresponding data can be stored on servers at remote location. The computing resources in cloud computing environments can be consolidated at remote data center locations or they can be dispersed. Cloud computing infrastructures can deliver services through shared data centers, even though they appear as a single point of access for user 906. Thus, the components and functions described herein can be provided from a service provider at a remote location using a cloud computing architecture. Alternatively, they can be provided from a conventional server, or they can be installed on client devices directly, or in other ways.

In the embodiment shown in FIG. 6, some items are similar to those shown in FIG. 1, and they are similarly numbered. FIG. 6 specifically shows that platform 100 operates within cloud 902 (which can be public, private, or a combination where portions are public while others are private). Therefore, user 906 can use a user device 904 to access and interact with platform 100 through cloud 902.

FIG. 6 depicts an embodiment of cloud architecture where data stores 220-240 are disposed outside of cloud 902, and accessed through cloud 902. In another embodiment, data processing system 130 is also disposed outside of cloud 902. Regardless of where they are located, data stores 102, 112 and 120, and system 130 can be accessed directly by device 904, through a network (either a wide area network or a local area network). It can be hosted at a remote site by a service, or it can be provided as a service through a cloud or accessed by a connection service that resides in the cloud. All of these architectures are contemplated herein.

It will also be noted that system 130, or portions of it, can be disposed on a wide variety of different devices. Some of these devices include servers, desktop computers, laptop computer, tablet computers, or other mobile devices such as palm top computers, cell phones, smartphones, multi-media players, personal digital assistance, etc.

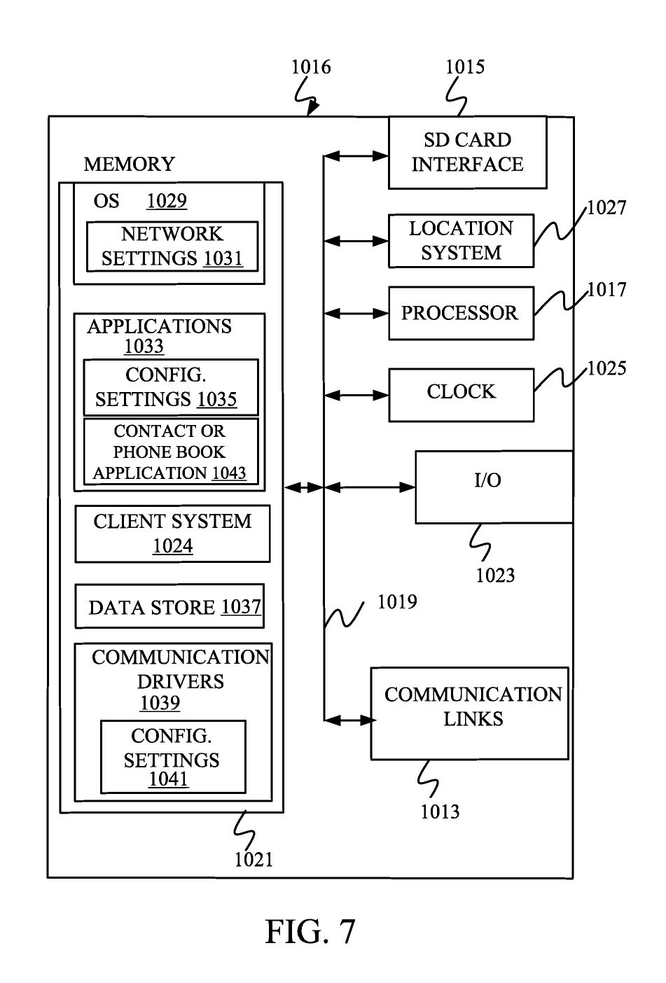

FIG. 7 is a simplified block diagram of one illustrative embodiment of a handheld or mobile computing device that can be used as a user's or client's handheld device 16 in which the present system (or parts of it) can be deployed. FIGS. 7-9 are examples of handheld or mobile devices. FIG. 7 provides a general block diagram of the components of a client device 16 that can run components or system 130 or then interacts with architecture 900, or both. In the device 16, a communications link 13 is provided that allows the handheld device to communicate with other computing devices, and under some embodiments, provides a channel for receiving information automatically, such as by scanning. Examples of communications link 13 include an infrared port, a serial/USB port, a cable network port such as an Ethernet port, and a wireless network port allowing communications through one of more communication protocols including General Packet RadioService (GPRS), LTE, HSPA, HSPA+ and other 3G and 4G radio protocols, 1Xrtt, and Short Message Service, which are wireless services used to provide cellular access to a network, as well as Wi-Fi protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor along a bus 19 that is also connected to memory 21 and input/output (I/O) components 23, as well as clock 25 and location system 27.

I/O components 23, in various embodiments, are provided to facilitate input and output operations. I/O components 23 of the device 16 can include input components such as buttons, touch sensors, multi-touch sensors, optical or video sensors, voice sensors, touch screens, proximity sensors, microphones, tilt sensors, and gravity switches and output components such as a display device, a speaker, and/or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, WAAS, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media. Memory 21 stores computer readable instructions that, when executed by processor 17, cause the processor to perform computer-implemented steps or functions according to the instructions. Items in data stores 102, 112 and 120, for example, can reside in memory 21. Similarly, device 16 can have a client business system 24 which can run various business applications. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

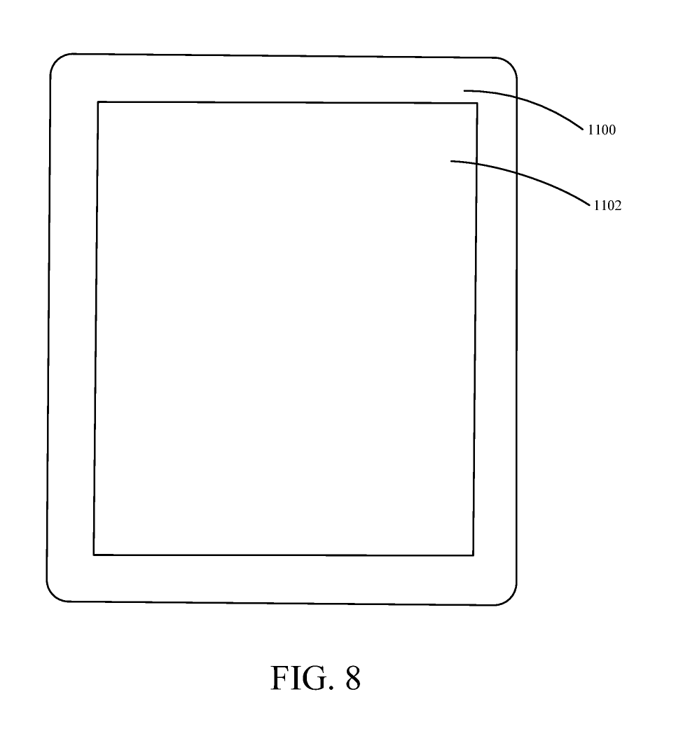

FIG. 8 shows one embodiment in which device 16 is a tablet computer 1100. Screen 1102 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 1100 can also illustratively receive voice inputs as well.

Tablet 1100 may be useful for a view of configurable element track platform 100 to review information received. For example, the interfaces presented in FIGS. 4A-4J could be presented using screen 1102 to a configurable element tracking administrator creating a new interaction rule. FIG. 5 could also be presented on screen 1102 of tablet 1100, for example, upon successfully meeting an element, and receiving a result, of an interaction rule.

Additional examples of device 16 can be used as well. Device 16 can be a feature phone, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1Xrtt, and Short Message Service (SMS) signals. In some examples the phone also includes a Secure Digital (SD) card slot that accepts a SD card.

The mobile device can also be a personal digital assistant or a multimedia player or a tablet computing device, etc. (hereinafter referred to as a PDA). The PDA can include an inductive screen that senses the position of a stylus (or other pointers, such as a user's finger) when the stylus is positioned over the screen. This allows the user to select, highlight, and move items on the screen as well as draw and write. The PDA can also include a number of user input keys or buttons which allow the user to scroll through menu options or other display options which are displayed on the display, and allow the user to change applications or select user input functions, without contacting the display. The PDA can also include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

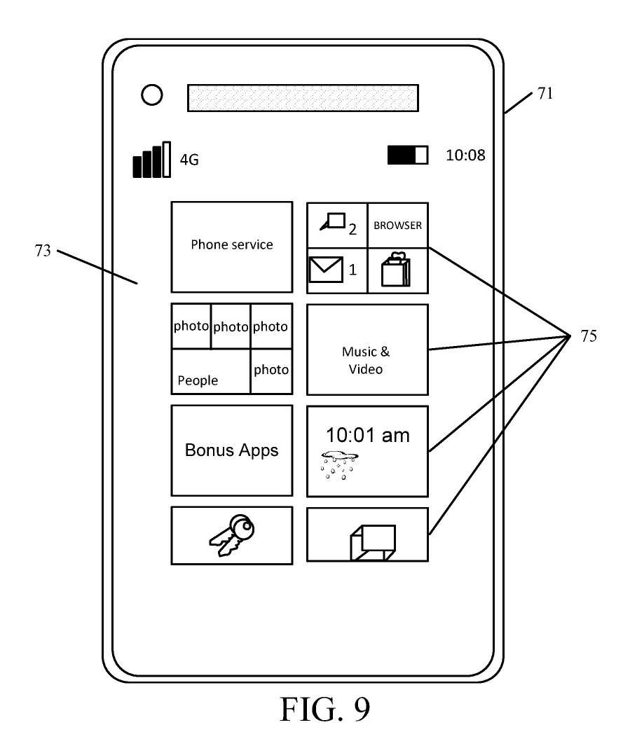

FIG. 9 is similar to FIG. 7 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the device 16 are possible.

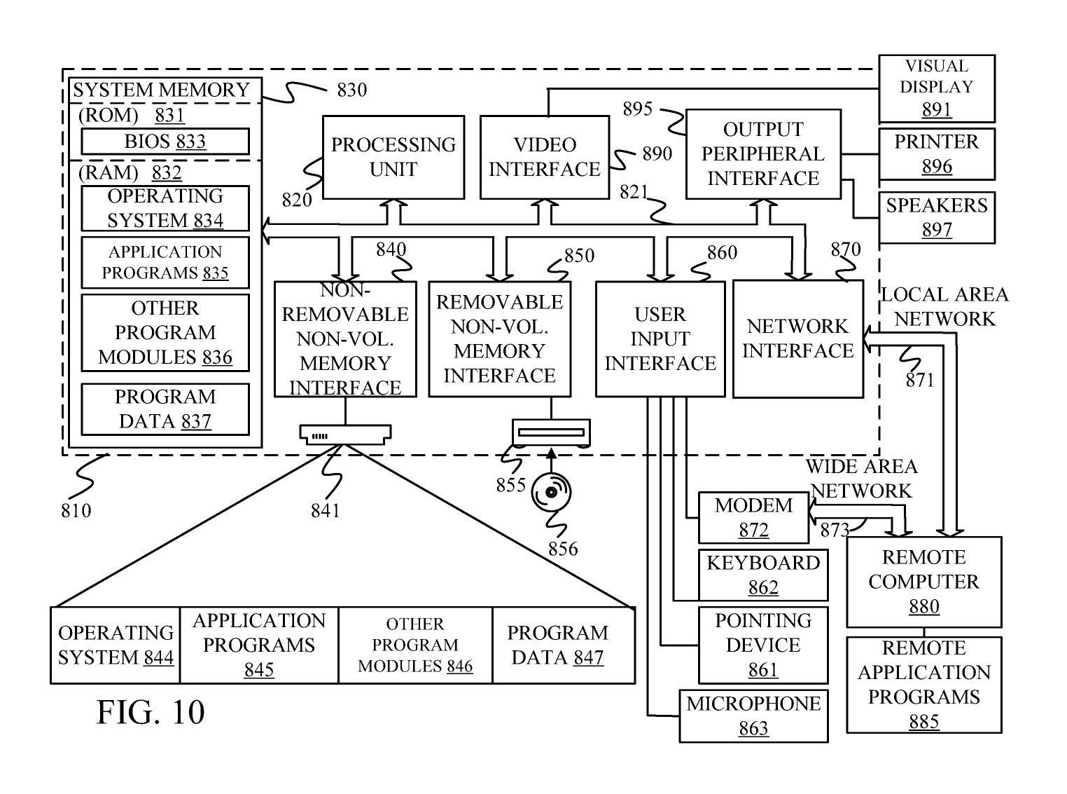

FIG. 10 is one embodiment of a computing environment in which platform 100, or parts of it, for example can be deployed. With reference to FIG. 10, an exemplary system for implementing some embodiments includes a general-purpose computing device in the form of a computer 1310. Components of computer 1310 may include, but are not limited to, a processing unit 1320, a system memory 1330, and a system bus 1321 that couples various system components including the system memory to the processing unit 1320. The system bus 1321 may be any of several types of bus structures including a memory bus or memory controller, a peripheral bus, or a local bus using any of a variety of bus structures. By way of example, and not by limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 1310 typically includes a variety of computer readable media. Computer readable media can be any available media that can be accessed by computer 1310 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to: RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1310. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 1330 includes computer storage media in the form of volatile and/or nonvolatile memory such as read only memory (ROM) 1331 and random access memory (RAM) 1332. A basic input/output system 1333 (BIOS), containing the basic routines that help to transfer information between elements within computer 810, such as during start-up, is typically stored in ROM 1331. RAM 1332 typically contains data and/or program modules that are immediately accessible to and/or presently being operated on by processing unit 1320. By way of example, and not limitation, FIG. 10 illustrates operating system 1334, application programs 1335, other program modules 1336, and program data 1337.

The computer 1310 may also include other removable/non-removable volatile/nonvolatile computer storage media. By way of example only, FIG. 10 illustrates a hard disk drive 1341 that reads from or writes to non-removable, nonvolatile magnetic media, a magnetic disk drive 1350 that reads from or writes to a removable, nonvolatile magnetic disk 1352, and an optical disk drive 1355 that reads from or writes to a removable, nonvolatile optical disk 1356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1341 is typically connected to the system bus 1321 through a non-removable memory interface such as interface 1340, and magnetic disk drive 1341 and optical disk drive 1355 are typically connected to the system bus 1321 by a removable memory interface, such as interface 1350.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 1310. In FIG. 10, for example, hard disk drive 1341 is illustrated as storing operating system 1344, application programs 1345, other program modules 1346, and program data 1347. Note that these components can either be the same as or different from operating system 1334, application programs 1335, other program modules 1336, and program data 1337. Operating system 1344, application programs 1345, other program modules 1346, and program data 1347 are given different numbers here to illustrate that, at a minimum, they are different copies.

A user may enter commands and information into the computer 1310 through input devices such as a keyboard 1362, a microphone 1363, and a pointing device 1361, such as a mouse, trackball or touch pad. Other input devices (not shown) may include a joystick, game pad, satellite dish, scanner, or the like. These and other input devices are often connected to the processing unit 1320 through a user input interface 1360 that is coupled to the system bus, but may be connected by other interface and bus structures, such as a parallel port, game port or a universal serial bus (USB). A visual display 1391 or other type of display device is also connected to the system bus 1321 via an interface, such as a video interface 1390. In addition to the monitor, computers may also include other peripheral output devices such as speakers 1397 and printer 1396, which may be connected through an output peripheral interface 1395.

The computer 1310 is operated in a networked environment using logical connections to one or more remote computers, such as a remote computer 1380. The remote computer 1380 may be a personal computer, a hand-held device, a server, a router, a network PC, a peer device or other common network node, and typically includes many or all of the elements described above relative to the computer 1310. The logical connections depicted in FIG. 13 include a local area network (LAN) 1371 and a wide area network (WAN) 1373, but may also include other networks. Such networking environments are commonplace in offices, enterprise-wide computer networks, intranets and the Internet.

When used in a LAN networking environment, the computer 1310 is connected to the LAN 1371 through a network interface or adapter 1370. When used in a WAN networking environment, the computer 1310 typically includes a modem 1372 or other means for establishing communications over the WAN 1373, such as the Internet. The modem 1372, which may be internal or external, may be connected to the system bus 1321 via the user input interface 1360, or other appropriate mechanism. In a networked environment, program modules depicted relative to the computer 1310, or portions thereof, may be stored in the remote memory storage device. By way of example, and not limitation, FIG. 10 illustrates remote application programs 1385 as residing on remote computer 1380. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the present invention has been described with reference to preferred embodiments, workers skilled in the art will recognize that changes may be made in form and detail without departing from the spirit and scope of the invention.

What is claimed is:

1. A configurable element tracking platform configured to provide an interaction indication, the platform comprising:
a database configured to store a user history for a user and an interaction criteria;
user action analyzer logic configured to receive an indication of an action by the user and identify an action indication;
a data processing system configured to retrieve, using interaction retrieval logic, the interaction indication, wherein the interaction indication comprises a criteria; and
wherein the data processing system is further configured to, using interaction check logic, compare the action indication to the criteria and, if the action indication matches the criteria, generate a match indication, using interaction alerting logic.

2. The configurable element tracking platform of claim 1, wherein the data processing system is configured to, using user activity updating logic, update the user history with an indication of the action indication.

3. The configurable element tracking platform of claim 2, wherein the data processing system is further configured to, on a user interface with a display, provide an indication of the user history.

4. The configurable element tracking platform of claim 1, wherein the data processing system is further configured to update the user history with the match indication.

5. An interaction generation platform comprising:
a data store comprising a plurality of interaction elements, wherein at least one interaction element is user-configurable;
a data processing system configured to generate an interaction rule, using interaction generation logic, wherein the generating the interaction rule comprises the data processing system, in response to receiving an interaction input, actuating stored instructions that cause the data processing system to:
receive a user indication selecting an interaction element from the plurality of interaction elements;
receive a user indication selecting an interaction result; and
provide an indication of the generated interaction rule; and
user interface surfacing logic configured to surface indications of the plurality of interaction elements on a computing device with a display.

6. The interaction generation platform of claim 5, wherein generating the interaction rule comprises the data processing system retrieving, using interaction retrieval logic, an existing interaction rule and wherein the generated interaction rule is a modification to the existing interaction rule.

7. The interaction generation platform of claim 5, wherein generating the interaction rule comprises the data processing system retrieving, using interaction retrieval logic, an interaction rule template, and wherein the generated interaction rule is a modification to the interaction rule template.

8. The interaction generation platform of claim 5, wherein the interaction element comprises a time-based element selected from the group consisting of: a start date, an end date, and a length of activity.

9. The interaction generation platform of claim 5, wherein the interaction element comprises a user action.

10. The interaction generation platform of claim 5, wherein the interaction element comprises a user membership.

11. The interaction generation platform of claim 5, wherein the interaction result is selected from the group consisting of: a discount, a point award, and a free item.

12. The interaction generation platform of claim 5, and further comprising:
a communication component configured to provide an indication of the generated interaction rule to a remote device.

13. A method of generating a user-configurable interaction rule on a configurable element tracking platform, the method comprising:
receiving, using user action analyzer logic an indication of an interaction rule from a user;
identifying, using element generation logic, an element associated with the interaction rule;
identifying, using result generation logic, a result associated with the interaction rule;
generating, using interaction generation logic, the interaction rule such that, when the rule is satisfied, the result is automatically applied; and
storing, using interaction storage logic, the interaction rule in a data store such that, when the rule is satisfied, interaction retrieval logic can retrieve the interaction rule and apply the result.

14. The method of claim 13, wherein the result is selected from the group consisting of: a discount, a point accrual, and a free item.

15. The method of claim 13, wherein the element is selected from the group consisting of: a user action, a membership, and a time period the interaction rule is active.

16. The method of claim 13, and further comprising:
in response to receiving the indication of an interaction rule, retrieving an interaction rule template.

17. The method of claim 13, and further comprising:
in response to receiving the indication of an interaction rule, retrieving an existing interaction rule for modification.

18. The method of claim 13, and further comprising:
surfacing, on a user interface, using user interface surfacing logic, an indication of the interaction rule.

19. The method of claim 13, wherein the user is a first user, the method further comprising:
providing, using a communication component, an electronic indication of the interaction rule, to a second user located remotely from the first user.

20. The method of claim 19, wherein the indication of the interaction rule is provided to the second user on a user interface of a device associated with the second user.
